(19) United States
(12) Patent Application Publication
(10) Pub. No.: US 2020/0057887 A1
(43) Pub. Date: Feb. 20, 2020

(54) TIME-SENSITIVE IMAGE DATA MANAGEMENT SYSTEMS AND METHODS FOR ENRICHING SOCIAL EVENTS

(71) Applicant: LEYEFE, INC., Seattle, WA (US)

(72) Inventor: Michael BLUME, Seattle, WA (US)

(73) Assignee: LEYEFE, INC., Seattle, WA (US)

(21) Appl. No.: 16/349,827

(22) PCT Filed: Nov. 7, 2017
(86) PCT No.: PCT/US2017/060452

§ 371 Date: May 14, 2019

Related U.S. Application Data
(60) Provisional application No. 62/421,937, filed on Nov. 14, 2016.

(51) Int. Cl. G06K 9/00; H04L 12/58; H04L 29/08; H04L 29/06; G06K 9/62

(52) U.S. Cl. CPC G06K 9/00677; H04L 51/32; G06Q 50/01; H04L 65/403; G06K 9/6231; H04L 67/306

(57) ABSTRACT

Methods and systems by which an identifier of a social event, attendee recognition data, and an image of an attendee are obtained. In some variants a portion of image data associated with the attendee recognition data is sent to a mobile client device in response both to a recipient authorization and to an image data selection identifying the portion of the image data.

### BACKGROUND

Network implementations for aggregating and sharing image data have existed for several years. Social media sites like Facebook® and YouTube® allow users to share photos or other image data easily among connected participants (followers or connections, e.g.). Such sharing becomes more complicated in depicting complex human interactions (sports or other social events, e.g.) in which the timing and skill of respective content creators are significant factors.

One early attempt to allow connected device users to share depictions of a social event is presented in U.S. Pat. No. 9,342,817 (“Auto-creating groups for sharing photos”). That disclosure featured recognition of people or objects depicted in a website database image either by their appearance or by prompting the device users. Such inefficient image data management has a narrow usefulness and, like other minor departures from ordinary data sharing via social media, fails to provide scalable content distribution affording adequate quality control for owners of the content during the social event.

### BRIEF DESCRIPTION OF THE DRAWINGS

FIG. 1 illustrates a top view of a social event at which one person wears an article that facilitates identification, another person has a device that can present image data, and another person has a device that can capture image data.

FIG. 3 illustrates several components of an exemplary video-platform server in accordance with one or more embodiments.

FIG. 2 illustrates an exemplary series of communications between video-platform server, partner device, and media-playback device that illustrate certain aspects of a platform, in accordance with one or more embodiments.

FIG. 4 illustrates a routine for providing a platform API, such as may be performed by a video-platform server in accordance with one or more embodiments.

FIG. 5 illustrates an exemplary context-aware media-rendering UI, such as may be provided by video-platform server and generated by media-playback device in accordance with one or more embodiments.

FIGS. 6-11 illustrate an exemplary context-aware media-rendering UI, such as may be provided by video-platform server and generated by media-playback device in accordance with one or more embodiments.

FIG. 12 illustrates several components of an exemplary client device in accordance with one or more embodiments.

FIG. 13 illustrates several components of client devices in an exemplary system in accordance with one or more embodiments.

FIG. 14 illustrates a method for implementing social-media-enhanced presentation annotation in accordance with one or more embodiments (performed by a server acting through respective client devices, e.g.).

FIG. 15 illustrates event-sequencing logic in an exemplary system in accordance with one or more embodiments.

FIG. 16 illustrates another method for presentation annotation in accordance with one or more embodiments (performed within a server or via distributed transistor-based circuitry, e.g.).

### DESCRIPTION

The detailed description that follows is represented largely in terms of processes and symbolic representations of operations by conventional computer components, including a processor, memory storage devices for the processor, connected display devices and input devices. Furthermore, some of these processes and operations may utilize conventional computer components in a heterogeneous distributed computing environment, including remote file servers, computer servers and memory storage devices.

The phrases “in one embodiment,” “in various embodiments,” “in some embodiments,” and the like are used repeatedly. Such phrases do not necessarily refer to the same embodiment. The terms “comprising,” “having,” and “including” are synonymous, unless the context dictates otherwise.

“Additionally,” “after,” “alternatively,” “annotated,” “applied,” “associated,” “at least,” “automatic,” “authorized,” “available,” “based,” “before,” “captured,” “concerning,” “digital,” “during,” “enhancement,” “event-specific,” “first,” “geographic,” “human,” “identifying,” “invoked,” “invoked,” “likewise,” “local,” “machine-detectable,” “notified,” “of,” “portable,” “remote,” “second,” “selected,” “social,” “stationary,” “taken,” “temporal,” “transmitted,” “unique,” “using,” “visual,” “wearable,” “within,” or other such descriptors herein are used in their normal yes-or-no sense, not as terms of degree, unless context dictates otherwise. In light of the present disclosure those skilled in the art will understand from context what is meant by “remote” and by other such positional descriptors used herein. Terms like “processor,” “center,” “unit,” “computer,” or other such descriptors herein are used in their normal sense, in reference to an inanimate structure. Such terms do not include any people, irrespective of their location or employment or other association with the thing described, unless context dictates otherwise. “For” is not used to articulate a mere intended purpose in phrases like “circuitry for” or “instruction for,” moreover, but is used normally, in descriptively identifying special purpose software or structures.

Reference is now made in detail to the description of the embodiments as illustrated in the drawings. While embodiments are described in connection with the drawings and related descriptions, there is no intent to limit the scope to the embodiments disclosed herein. On the contrary, the intent is to cover all alternatives, modifications and equivalents. In alternate embodiments, additional devices, or combinations of illustrated devices, may be added to, or combined, without limiting the scope to the embodiments disclosed herein.

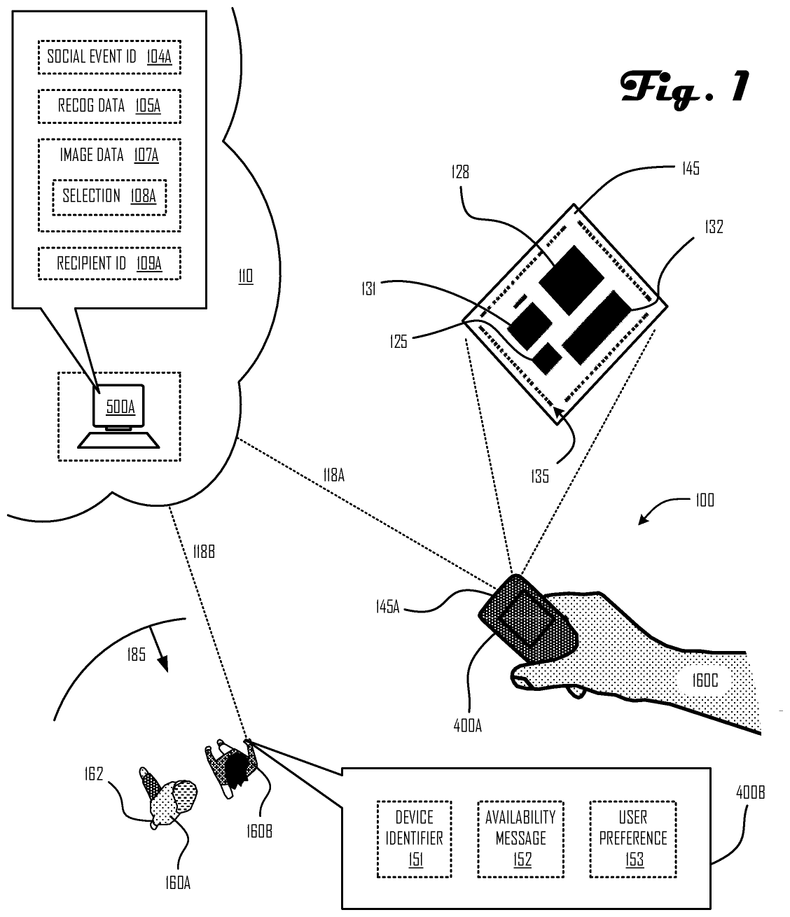

FIG. 1 illustrates a (view from above of a) social event at which one person 160A wears an article 162 that facilitates identification, another person 160B has a device that can present image data, and another person 160C has a device that can capture the image data. In the system 100 depicted, a first portable device 400A is configured to include a camera 145A. Portable device 400A also includes an integrated circuit 145 (a camera chip or other Application-Specific Integrated Circuit, e.g.) having one or more instances of special-purpose modules 125, 128; one or more memories 131, 132, and numerous bonding pads 135 (each an example of an electrical node as described herein) by which communicative and other electrical coupling is made (to other modules within portable device 400A, e.g.). Image data 107A at a social event designated by a social event identifier 104A is captured (via one or more portable devices 400A, e.g.) and transmitted to network 110 (via a wireless linkage 118A to one or more servers 500A, e.g.). In some contexts, additional image data 107A may be captured at the same social event (by other portable devices 400A held by another person 160C or airborne drone, e.g.) and aggregated in network 110. Alternatively or additionally, one or more of such servers may be remote from a vicinity 185 of the social event.

As further described below, an image data selection 108A may be generated at (a remote instance of) server 500A by matching recognition data 105A associated with a particular person 160A depicted in some of the images of image data 107A or by applying other criteria (wearing an inclusion-indicative or exclusion-indicative wearable tag, e.g.) defined by one or more persons 160C who have requested the image capture(s).

Alternatively or additionally, other parties may likewise affect the image data selection(s) 108A that are ultimately transmitted to another portable device 400B at the social event (in use by person 160B, e.g.). Such other parties may include one or more of depicted persons 160A, persons 160B who receive the image data selection 108A, a content enhancement service provider (image editor, e.g.) who operates server 500A, or others as described herein. Alternatively or additionally, such image data selection 108A may be downloaded via bandwidth-limited linkage 118B. In some variants, one or more other image data selections may be transmitted directly via a local direct linkage (passing through wire or other local passive media directly from device 400A to device 400B, e.g.) in lieu of any active network linkages. Alternatively or additionally, an image data recipient's portable device 400B may present or use one or more instances of device identifiers 151; availability messages 152 (notifications each identifying a respective selection 108A of image data 107A, e.g.); or user preferences 153 (manifesting what kinds of selections 108A person 160B apparently wants to receive, e.g.).

FIG. 2 illustrates a memory 204 containing one or more instances of image data 285 and one or more instances of attendee recognition data 295 (one or more of which may applied as attendee recognition data 105. Such image data 285 may include one or more instances photographs 281 or of video clips 282, for example, as shown. Likewise such attendee recognition data 295 may include one or more instances of printouts 291 (wearable identification stickers or QC codes, e.g.), of unique chip identifiers (Radio-Frequency Identification tags, e.g.) each worn by an attendee, of other wearables 293, or of other patterns 294 suitable for rapid identification as described herein.

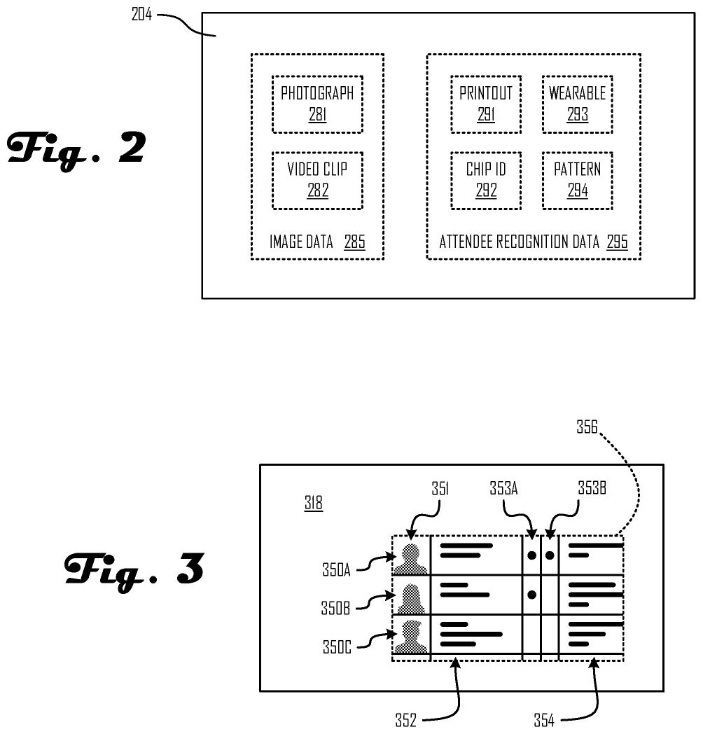

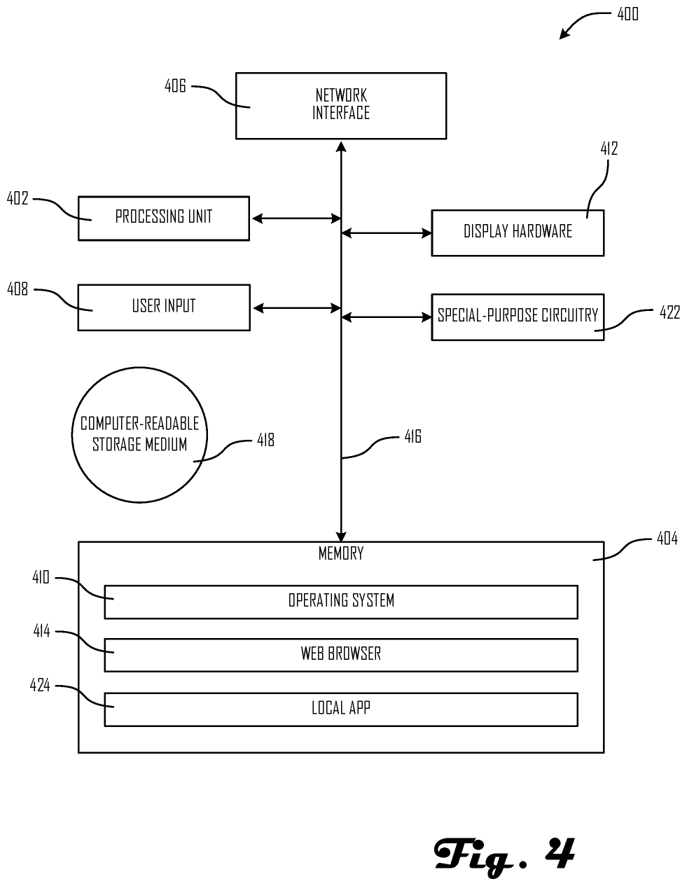

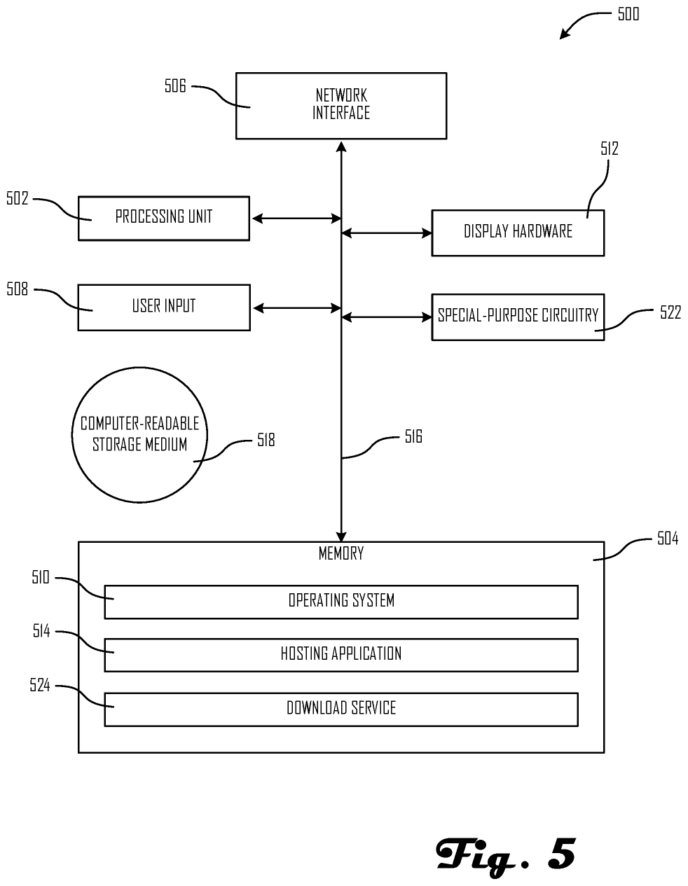

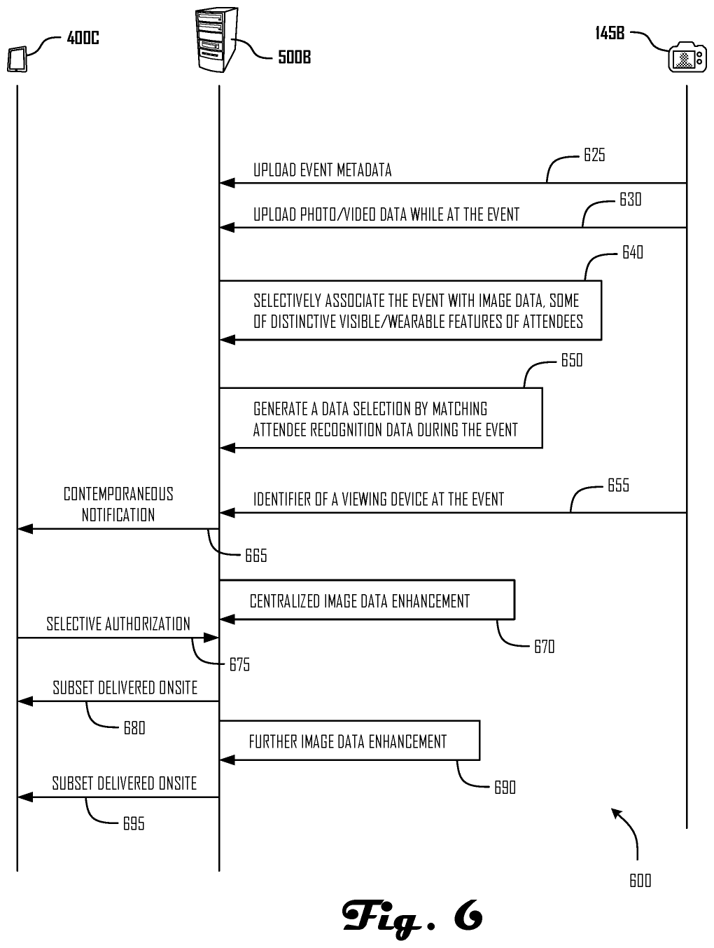

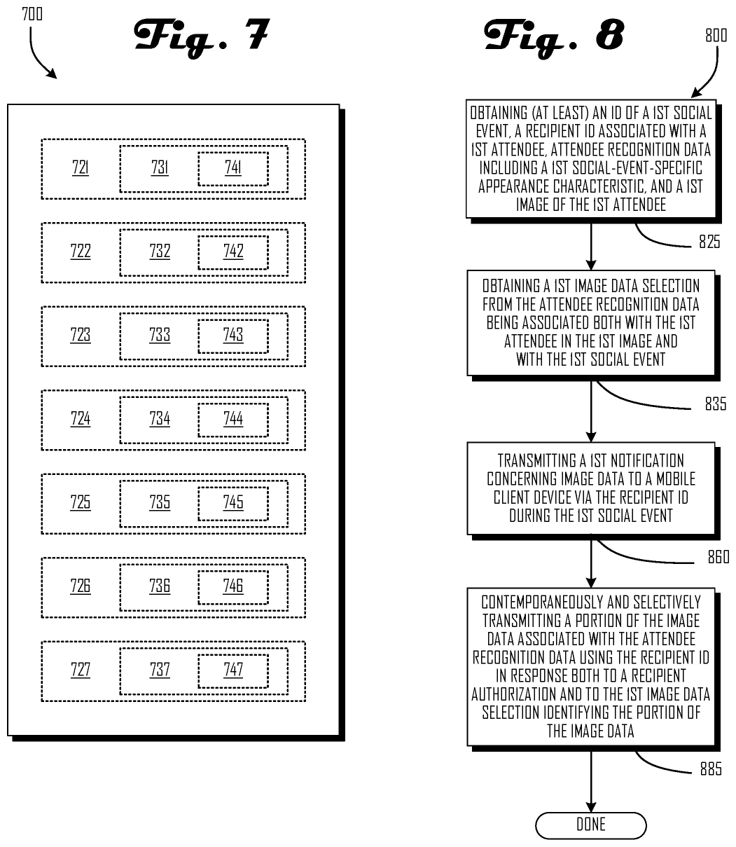

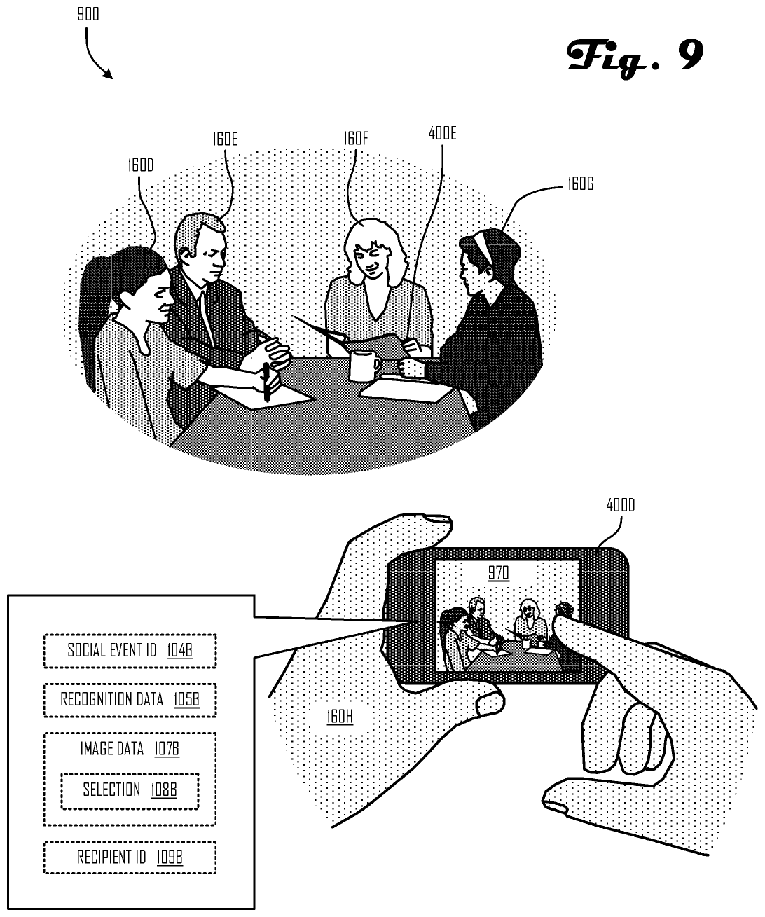

FIG. 3 illustrates a storage medium 318 containing tabular data 356 (a relational database, e.g.) including a table of (registered or actual) attendees of a social event as described herein. Each of records 350A-C, for example, may include a current image 351 of the person 160 to whom it relates in association with one or more identifications 352 of the person and other data 354 about the person as described herein. Each such record 350 may likewise include a Boolean indication 353A whether or not that person's likeness as described herein is desired by a recipient as described herein for selective inclusion in a data selection 108 as described herein. Alternatively or additionally, each such record 350 may likewise include a Boolean indication 353B whether or not that person's likeness as described herein is authorized by that person (whose picture is taken) as described herein for any inclusion in image data as described herein (as contrasted with that person reserving his/her right of publicity by withholding such authorization. Matching persons 160 depicted in image data 107 during the social event is made feasible by the use of limited data sets (searching primarily through tabular data 356 depicting attendees, e.g.) pertaining to attendees. Only very limited or optional searching for matches in larger populations is feasible for time-sensitive image data management as described herein.

FIG. 4 illustrates several components of an exemplary portable device 400. In some embodiments, portable device 400 may include many more components than those shown in FIG. 4. However, it is not necessary that all of these generally conventional components be shown in order to disclose an illustrative embodiment. As shown in FIG. 4, portable device 400 includes a data network interface 406 for connecting to data network 110.

Portable device 400 may also include one or more instances of processing unit 402, a memory 404, display hardware 412, and special-purpose circuitry 422 all interconnected along with the network interface 406 via a bus 416. Memory 404 generally comprises a random access memory (“RAM”), a read only memory (“ROM”), and a permanent mass storage device, such as a disk drive.

Special-purpose circuitry 422 may, in some variants, include some or all of the event-sequencing logic described below (with reference to FIG. 7, e.g.). Storage medium 418 may likewise instantiate storage medium 318 as described above. Alternatively or additionally, in some variants memory 404 may instantiate memory 204 as described above.

In addition, memory 404 also contains an operating system 410, browser application 414, and downloaded local 424 (or routines for access to a remote database). These and other software components may be loaded from a non-transitory computer readable storage medium 418 into memory 404 of the portable device 400 using a drive mechanism (not shown) associated with a non-transitory computer readable storage medium 418, such as a floppy disc, tape, DVD/CD-ROM drive, flash card, memory card, or the like. In some embodiments, software components may also be loaded via the network interface 430, rather than via a computer readable storage medium 418.

FIG. 5 illustrates several components of an exemplary server 500. In some embodiments, server 500 may include many more components than those shown in FIG. 5. However, it is not necessary that all of these generally conventional components be shown in order to disclose an illustrative embodiment. As shown in FIG. 5, server 500 includes a data network interface 506 for connecting to data network 110.

Server 500 may also include one or more instances of processing unit 502, a memory 504, display hardware 512, all interconnected along with the network interface 506 via a bus 516. Memory 504 generally comprises a random access memory (“RAM”), a read only memory (“ROM”), and a permanent mass storage device, such as a disk drive.

In addition, memory 504 also contains an operating system 510, hosting application 514, and download service 524 (or routines for access to an external database). These and other software components may be loaded from a non-transitory computer readable storage medium 518 into memory 504 of the server 500 using a drive mechanism (not shown) associated with a non-transitory computer readable storage medium 518, such as a floppy disc, tape, DVD/CD-ROM drive, flash card, memory card, or the like. In some embodiments, software components may also be loaded via the network interface 530, rather than via a computer readable storage medium 518.

Special-purpose circuitry 522 may, in some variants, include some or all of the event-sequencing logic described below (with reference to FIGS. 6-8, e.g.). Storage medium 518 may likewise instantiate storage medium 318 as described above. Alternatively or additionally, in some variants memory 504 may instantiate memory 204 as described above.

FIG. 6 illustrates a flow 600 with an exemplary series of communications suitable for use with at least one embodiment. Before or during a social event, event metadata thereof, including event-specific recognition data, is uploaded 625 from one or more portable devices 400 (camera 145B, e.g.) to one or more servers 500B. Image data 107 is likewise uploaded during the social event 630. Each item of image data 107 is selectively associated 640 with the social event(s) at which it was taken. Where possible, one or more device-recognizable items of distinctive/wearable features depicted in the image are also matched so as to identify at least some of the attendees in the image data 107 during the social event (using the attendee recognition data 295 taken from the limited set of tabular data 356 pertaining to registered attendees if applicable, e.g.). Other sequences are also contemplated, such as an aggregation of pictures of a guy in a red tie who is not registered until later during the event.

One or more identifiers of a viewing device (portable device 400B, e.g.) present at the event are also obtained 655, either via a local image capture device (portable device 400A, e.g.) or by contacting server 500B directly. The viewing device receives a contemporaneous notification 665 signifying a successful engagement with server 500B or a suitable selection 108 of image data being ready for download. Meanwhile one or more photographs 281 or video clips 282 (uploaded from camera 145B, e.g.) may undergo centralized image data enhancement 670 (cropping, annotation, or the like performed offsite by remote personnel, e.g.) shortly after upload so that after an appropriate request/order (as selective authorization 675, e.g.) the best available selection 108 of image data will be delivered (as image data subset delivered onsite 680, e.g.) to the social event.

Portions of flow 600 may be performed iteratively. For example where modifications are requested (as another selective authorization, e.g.), further image data enhancement 690 may be performed and the resulting subset delivered onsite 695.

FIG. 7 illustrates special-purpose transistor-based circuitry 700—optionally implemented as an Application-Specific Integrated Circuit (ASIC), e.g.—in which some or all of the functional modules described below may be implemented. Transistor-based circuitry 700 is an event-sequencing structure generally as described in U.S. Pat. Pub. No. 2015/0094046 but configured as described herein. Transistor-based circuitry 700 may include one or more instances of modules 721-724 configured for local processing, for example, each including an electrical node set 731-734 upon which informational data is represented digitally as a corresponding voltage configuration 741-744. In some variants, moreover, an instance of modules 721-724 may be configured for invoking such local processing modules remotely in a distributed implementation. Transistor-based circuitry 700 may likewise include one or more instances of modules 725-727 configured for programmatic response as described below, for example, each including an electrical node set 735-737 upon which informational data is represented digitally as a corresponding voltage configuration 745-747. In some variants, an instance of modules 725-725 may be configured for invoking such programmatic response modules remotely in a distributed implementation.

As used herein, “processing module” refers to transistor-based circuitry that performs encoding, pattern matching, or other data-transformative operations generally as described herein. “Invocation module” refers to control circuitry that configures and triggers communication and processing modules or other event-sequencing logic generally as described herein. In light of teachings herein, those skilled in the art will be able to configure processing and implementation modules (and other modules also) within special-purpose circuitry 422, 522 of a single device 400 or server 500 or in a distributed implementation (with respective modules 721-727 constructed and arranged in respective systems of a cooperative network 110, e.g.).

In the interest of concision and according to standard usage in information management technologies, the functional attributes of modules described herein are set forth in natural language expressions. It will be understood by those skilled in the art that such expressions (functions or acts recited in English, e.g.) adequately describe structures identified below so that no undue experimentation will be required for their implementation. For example, any records or other informational data identified herein may easily be represented digitally as a voltage configuration on one or more electrical nodes (conductive pads of an integrated circuit, e.g.) of an event-sequencing structure without any undue experimentation. Each electrical node is highly conductive, having a corresponding nominal voltage level that is spatially uniform generally throughout the node (within a device or local system as described herein, e.g.) at relevant times (at clock transitions, e.g.). Such nodes (lines on an integrated circuit or circuit board, e.g.) may each comprise a forked or other signal path adjacent one or more transistors. Moreover many Boolean values (yes-or-no decisions, e.g.) may each be manifested as either a “low” or “high” voltage, for example, according to a complementary metal-oxide-semiconductor (CMOS), emitter-coupled logic (ECL), or other common semiconductor configuration protocol. In some contexts, for example, one skilled in the art will recognize an “electrical node set” as used herein in reference to one or more electrically conductive nodes upon which a voltage configuration (of one voltage at each node, for example, with each voltage characterized as either high or low) manifests a yes/no decision or other digital data.

FIG. 8 illustrates an operational flow 800 in which one or more technologies may be implemented (within or in conjunction with one or more servers 500, e.g.). At operation 825, an identifier of a first social event, a recipient identifier associated with (at least a device of) a first attendee, attendee recognition data including a 1st social-event-specific appearance characteristic, and a first image of the first attendee are obtained (one or more invocation or processing modules 721-724 of special-purpose circuitry 422, 522 receiving or generating such items, e.g.). This can occur, for example, in a context in which the social event is a festival or a convention (having an alphanumeric social event identifier 104A digitally encoded as a voltage configuration 741 on an electrical node set 731, e.g.); in which person 160A is the “first attendee”; and in which the recipient identifier is a device identifier 151 (a phone number, Internet Protocol address, or e-mail address digitally encoded as a voltage configuration 742 on an electrical node set 732, e.g.) selectively associated with a person 160B that has expressed an interest in depictions of the first attendee. In some contexts, for example, such interest may have been manifested (by person 160B as the recipient, e.g.) by the recipient having identified a distinctive logo, color, nametag, costume, or other device-recognizable pattern 294 presented at the social event by at least the first attendee (but not by some others) at the social event as the first social-event-specific appearance characteristic. See FIG. 9. Alternatively or additionally, a portable device 400A that captures the first image (and includes a recognition module, e.g.) is configured to read a printout 291 (in a printed nametag or logo, e.g.) or chip identifier 292 (in an RFID tag, e.g.) worn by the first attendee (as one or more distinctive appearance characteristics, e.g.) so as to facilitate identification of (at least) the first attendee in visual depictions (tagging the first attendee in a photograph 281 or video clip 282 comprising the first image, e.g.).

At operation 835, a first image data selection from the attendee recognition data being associated both with the first attendee in the first image and with the first social event is obtained (one or more invocation or processing modules 725 of special-purpose circuitry 422, 522 triggering or implementing such associations, e.g.). This can occur, for example, in a context in which the attendee recognition data 295 (digitally encoded as a voltage configuration 743 on an electrical node set 733, e.g.) includes a barcode or nametag pattern 294 that facilitates an automatic and rapid identification of particular image data 107A (as the selection 108A, e.g.); in which a storage address or other metadata about the first image is digitally encoded as a voltage configuration 744 on an electrical node set 734; in which image data 285 depicting members of a party comprising the first attendee (in a visually recognizable cohort, e.g.) is substantially included; and in which other image data 107A (not including any member of the party, e.g.) generally is not. In some variants, for example, (an instance of) a processing module 723 is configured to include photographs 281 or video clips 282 of people wearing a particular color (and generally not other people) and the “first image” is consequently included in the resulting selection 108A. Alternatively or additionally, the processing module may be configured to facilitate operation 835 by determining whether or not each item of image data 285 exhibits a social-event-specific appearance characteristic (makeup, facial hair, a costume, or other such device-recognizable wearable material, e.g.) generated during or just before the event (in an image 351 of a record 350B in a table of registered attendees, e.g.).

At operation 860, a first notification concerning image data is transmitted to a mobile client device at the first social event using the recipient identifier (one or more invocation or response modules 725 of special-purpose circuitry 422, 522 transmitting such data, e.g.). This can occur, for example in a context in which the first notification takes the form of an availability message 152 (a robocall, SMS text message, email, or similar automatic announcement, e.g.) received at portable device 400B during the event and in which the notification is digitally encoded as a voltage configuration 745 on an electrical node set 735. Alternatively or additionally, such notification may include an articulation of an exact form of what data product (saying “30 second video clip ready for download” or otherwise articulating one or more categorical or quantified descriptions of the selection 108A, e.g.) has become available for download, a real-time audible alert (a beep or other user-discernable event that occurs within 5 seconds of such availability, e.g.), a distillation of the data (a thumbnail or still frame photograph representative of the specific data product, e.g.), a price of the product, or a combination of these.

At operation 885, a portion of the image data associated with the attendee recognition data is transmitted to the mobile client device using the recipient identifier at least partly in response both to a recipient authorization and to the first image data selection identifying the portion of the image data (one or more invocation or response modules 727 of special-purpose circuitry 422, 522 transmitting such data during the social event in response to the person 160B expressing a selective authorization 680, e.g.). This can occur, for example in a context in which such authorization takes the form of a user preference 153 manifested in portable device 400B before the social event begins (as a menu selection in an app that resides in portable device 400B or a record 350C relating to person 160B, e.g.); in which such data (selection 108A, e.g.) takes the form of one or more photographs 281 or video clips 282 consistent with one or more user preferences 153; in which the preference or other authorization is digitally encoded as a voltage configuration 746 on an electrical node set 736; and in which an identification of the selection 108A to be downloaded to portable device 160B is digitally encoded as a voltage configuration 747 on an electrical node set 737. In some contexts, for example, selection 108A may include a subset of image data 107A delivered onsite 690 and after having undergone centralized image enhancement 675 (cropping, annotating, or other professional editing via a server 500 remote from the social event, e.g.) before the end of the social event and according to the one or more user preferences 153 (item size not to exceed X megabytes or clip duration not to exceed Y minutes, X or Y having been specified by person 160B, e.g.). Alternatively or additionally, the size and item type(s) of selection 108A may be selected according to a portable device category (having a high storage capacity, e.g.) or portable device status (currently using a low-bandwidth linkage wireless linkage 118B, e.g.) of the portable device 400B to which such data may be downloaded. In some variants, moreover, such selection(s) may be downloaded (to another device, e.g.) during the social event so that depictions of the social event are available for viewing immediately after the social event (being reviewable on a home computer system immediately after person 160B gets home from the social event, e.g.).

FIG. 9 illustrates another social event (a negotiation or conference, e.g.) at which one person 160G wears an article (a black jacket, e.g.) that facilitates identification, another person 160F has a device that can present image data (a “recipient device” that can present image 970), and another person 160H has a device 400D that can capture the image data. In the system 900 depicted, image data 107B at a social event designated by a social event identifier 104B is captured (via one or more portable devices 400A, e.g.) and transmitted to network 110 or via a direct link through a single local passive media to the recipient device (an ad hoc service like AirDrop®, e.g.) or to a local storage medium 418. In some contexts, additional image data 107B may be captured at the same social event and aggregated.

As further described below, an image data selection 108B may be generated at device 400D by matching recognition data 105B associated with a particular person 160G depicted in some of the images of image data 107B or by applying other criteria defined by one or more persons 160H who have requested the image capture(s). Alternatively or additionally, other parties may likewise affect the image data selection(s) 108B that are ultimately transmitted to another portable device 400 at the social event (in use by person 160F, e.g.). Such other parties may include one or more of depicted persons 160G, persons 160F who receive the image data selection 108B, an onsite content enhancement service provider (image editor, e.g.), or others as described herein.

In light of teachings herein, numerous existing techniques may be applied for configuring special-purpose circuitry or other structures effective for obtaining and applying user preferences, recognition criteria, data associations, or other operational parameters as described herein without undue experimentation. See, e.g., U.S. Pat. No. 9,443,001 (“Method and system to curate media collections”); U.S. Pat. No. 9,367,572 (“Metadata-based file-identification systems and methods”); U.S. Pat. No. 9,342,817 (“Auto-creating groups for sharing photos”); U.S. Pat. No. 9,135,278 (“Method and system to detect and select best photographs”); U.S. Pat. No. 8,718,256 (“Method and system for providing ring back tone played at a point selected by user”); U.S. Pat. No. 8,666,375 (“Customizable media auto-reply systems and methods”); U.S. Pat. No. 8,156,139 (“Media playing on a portable media player including shop and play remote media”); U.S. Pat. No. 7,987,280 (“System and method for locating and capturing desired media content from media broadcasts”); U.S. Pat. No. 7,882,034 (“Digital rights management for content rendering on playback devices”); U.S. Pat. No. 7,617,296 (“Data compilation system and method”); U.S. Pat. No. 7,461,055 (“Method and apparatus for recommending selections based on preferences in a multi-user system”); U.S. Pat. No. 7,430,506 (“Preprocessing of digital audio data for improving perceptual sound quality on a mobile phone”); U.S. Pub. No. 2015/0067077 (“Private messaging and private social network method for creating personal and private online communities through connecting user(s) utilizing physical objects and/or products and associated unique code(s) linked to users, messages, activities, and/or information”); and U.S. Pub. No. 2014/0053061 (“System for clipping web pages”). These documents are incorporated herein by reference to the extent not inconsistent herewith.

In some variants, any of the above-described flows (like flow 600 or flow 800, e.g.) may include obtaining an identifier of a first social event, a first recipient identifier associated with first attendee, attendee recognition data including a first social-event-specific appearance characteristic (optionally used in conjunction with one or more additional characteristics, e.g.), and a first image of the first attendee. They may likewise include obtaining a first image data selection from the attendee recognition data, being associated both with the first attendee in the first image and with the first social event; transmitting a first notification concerning image data to a portable device of a first recipient at the first social event using the first recipient identifier; and transmitting a portion of the image data associated with the attendee recognition data to the portable device using the first recipient identifier at least partly in response both to a recipient authorization and to the first image data selection identifying the portion of the image data.

Alternatively or additionally, such flows may include uploading first and second video data associated with the social event, at least one of which includes the image of the first attendee taken at the event; and receiving at the portable device during the social event the first video data associated with the social event but not the second video data associated with the social event in response to a human being having selected the first video data and not the second video data according to the human being having applied the attendee recognition data to the first and second video data associated with the social event remotely from the social event during the social event.

Alternatively or additionally, such appearance characteristics may include a distinctive wearable 162 or other material (makeup, facial hair, or a costume, e.g.). Such machine-detectable event-specific attendee characteristic may uniquely identify the first person 160A or may identify a team, party, or class of social event attendees (including person 160A, e.g.) subject to visual depiction. In some contexts, image data enhancement 670, 690 as described above may include obfuscation of or exclusion of one or more attendees 160C who have requested not to be depicted in any selections 108 until/unless authorization is provided for them to be included. This can occur, for example, in a context in which such persons (celebrities, e.g.) might otherwise be unwilling to attend the social event.

Alternatively or additionally, such flows may include uploading first and second video data associated with the social event, at least one of which includes the image of the first attendee taken at the event; and receiving at the portable device during the social event the first video data associated with the social event but not the second video data associated with the social event in response to a human being having selected the first video data and not the second video data according to the human being having applied the attendee recognition data to the first and second video data associated with the social event remotely from the social event during the social event.

Alternatively or additionally, one or more records 350 may associate image data selections as described above with attendee recognition data or with one or more particular attendees (or both). Alternatively or additionally, one or more records 350 may associate each applied set of attendee recognition data 105 with each respective selection 108 of the image data 107 in which it results.

Alternatively or additionally, such flows may include uploading video data associated with the social event that includes the image of the first attendee taken at the event; and transmitting the video data to the social event during the social event, at least some of which has been edited during the social event remotely from the social event.

Alternatively or additionally, such flows may include uploading a first video segment (video clip 282, e.g.) from a first digital camera 145 (by a first photographer) at the event; capturing a second video segment from the first digital camera at the event at the first digital camera according to one or more specifications received from the first attendee (different lens/filter/location/sampling rate); and uploading the second video segment from the first digital camera at the event.

Alternatively or additionally, such flows may include uploading a first video segment from a first digital camera (by a first videographer) at the event; capturing a second video segment from a second digital camera at the event at the first digital camera according to one or more specifications received from a customer (at the event or not, attendee or not); and uploading the second video segment from the second digital camera at the event.

Alternatively or additionally, such flows may include associating a video segment with a still image; transmitting the still image to the portable device at the event; and transmitting the video segment to the portable device at the event as a conditional response to a request from the portable device.

Alternatively or additionally, such flows may include obtaining a first record that associates the first social event with a particular motor vehicle or with a particular stationary zone (in a vicinity of a standing structure, e.g.).

Alternatively or additionally, such flows may include obtaining a first record that associates both a first digital camera and said first image with said first attendee at the social event, obtaining a second record that associates both a second digital camera and a second image with said first attendee at the first social event, and presenting both the first and second images to the first attendee at the first social event.

Alternatively or additionally, such selections 108 may be aggregated by temporal proximity to a later timestamp of the first image (e.g. having been captured within X1 minutes before the timestamp, where X1 is obtained as a user preference 153). Alternatively or additionally, such selections 108 may be aggregated by temporal proximity to an earlier timestamp of the first image (e.g. having been captured within X2 minutes before the timestamp, where X2 is obtained as a user preference 153). Alternatively or additionally, such selections 108 may be aggregated by geographic proximity to a coordinate set of the first image (e.g. having been captured within X3 meters of where the first image was taken, where X3 is obtained as a user preference 153).

Alternatively or additionally, such flows may include

In some variants, such flows may include receiving the first recipient identifier from a portable device associated with a second recipient during the social event, the first recipient identifier being an identifier (a telephone number or other device identifier, e.g.) of the portable device of the first recipient. Alternatively, said first recipient identifier may be received from a portable device associated with an image capture specialist (photographer or videographer, e.g.) during the social event.

With respect to method embodiments described herein, those skilled in the art will appreciate that recited operations therein may generally be performed in any order. Also, although various operational flows are presented in a sequence(s), it should be understood that the various operations may be performed in other orders than those which are illustrated, or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

1. An image management method comprising:
invoking transistor-based circuitry configured to obtain an identifier of a first social event, a recipient identifier associated with a first attendee, attendee recognition data including a first social-event-specific appearance characteristic, and a first image of the first attendee;
invoking transistor-based circuitry configured to obtain a first image data selection from the attendee recognition data being associated both with the first attendee in the first image and with the first social event; and
transmitting a first notification concerning image data to a mobile client device at the first social event using the recipient identifier; and
selectively transmitting a portion of the image data associated with the attendee recognition data to the mobile client device using the recipient identifier at least partly in response both to a recipient authorization and to the first image data selection identifying the portion of the image data.

2. The image management method of claim 1, wherein said selectively transmitting said portion of the image data associated with the attendee recognition data to the mobile client device comprises:
selectively transmitting said portion of the image data associated with the attendee recognition data to the mobile client device using the recipient identifier at least partly in response both to the recipient authorization and to the first image data selection identifying the portion of the image data in response to the recipient expressing a selective authorization, wherein the portion of the image data takes the form of one or more photographs.

3. The image management method of claim 1, wherein said selectively transmitting said portion of the image data associated with the attendee recognition data to the mobile client device comprises:
selectively transmitting said portion of the image data associated with the attendee recognition data to the mobile client device using the recipient identifier at least partly in response both to the recipient authorization and to the first image data selection identifying the portion of the image data in response to the recipient expressing a selective authorization, wherein the portion of the image data takes the form of one or more video clips.

4. The image management method of any of the above claims, wherein said selectively transmitting said portion of the image data associated with the attendee recognition data to the mobile client device comprises:
transmitting a portion of the image data associated with the attendee recognition data to the mobile client device using the recipient identifier at least partly in response both to a recipient authorization and to the first image data selection identifying the portion of the image data, wherein the first social-event-specific appearance characteristic includes a distinctive wearable material and wherein the first social-event-specific appearance characteristic is a machine-detectable event-specific attendee characteristic that uniquely identifies a team, party, or class of social event attendees that include the first attendee.

5. The image management method of any of the above claims, wherein said selectively transmitting said portion of the image data associated with the attendee recognition data to the mobile client device comprises:
selectively transmitting said portion of the image data associated with the attendee recognition data to the mobile client device using the recipient identifier at least partly in response both to the recipient authorization and to the first image data selection identifying the portion of the image data during the social event.

6. The image management method of any of the above claims, wherein said selectively transmitting said portion of the image data associated with the attendee recognition data to the mobile client device comprises:
selectively transmitting said portion of the image data associated with the attendee recognition data to the mobile client device using the recipient identifier at least partly in response both to the recipient authorization and to the first image data selection identifying the portion of the image data in response to the recipient expressing a selective authorization in the form of a user preference manifested in the mobile client device.

7. The image management method of any of the above claims, wherein said selectively transmitting said portion of the image data associated with the attendee recognition data to the mobile client device comprises:
selectively transmitting said portion of the image data associated with the attendee recognition data to the mobile client device using the recipient identifier at least partly in response both to the recipient authorization and to the first image data selection identifying the portion of the image data in response to the recipient expressing a selective authorization in the form of a user preference manifested in the mobile client device before the social event begins.

8. The image management method of any of the above claims, wherein said selectively transmitting said portion of the image data associated with the attendee recognition data to the mobile client device comprises:
selectively transmitting said portion of the image data associated with the attendee recognition data to the mobile client device using the recipient identifier at least partly in response both to the recipient authorization and to the first image data selection identifying the portion of the image data in response to the recipient expressing a selective authorization in the form of a user preference manifested in the mobile client device as a record relating to the recipient.

9. The image management method of any of the above claims, wherein said selectively transmitting said portion of the image data associated with the attendee recognition data to the mobile client device comprises:
selectively transmitting said portion of the image data associated with the attendee recognition data to the mobile client device using the recipient identifier at least partly in response both to the recipient authorization and to the first image data selection identifying the portion of the image data in response to the recipient expressing a selective authorization in the form of a user preference manifested in the mobile client device as a record relating to the recipient, wherein said first image data selection includes a subset of image data delivered onsite and after having undergone centralized image enhancement remote from the social event before the end of the social event.

10. The image management method of any of the above claims, wherein said selectively transmitting said portion of the image data associated with the attendee recognition data to the mobile client device comprises:
selectively transmitting said portion of the image data associated with the attendee recognition data to the mobile client device using the recipient identifier at least partly in response both to the recipient authorization and to the first image data selection identifying the portion of the image data in response to the recipient expressing a selective authorization in the form of a user preference manifested in the mobile client device as a record relating to the recipient, wherein said first image data selection includes a subset of image data delivered onsite and after having undergone centralized image enhancement remote from the social event before the end of the social event and according to the one or more size limitations specified by the recipient.

11. The image management method of any of the above claims, wherein said selectively transmitting said portion of the image data associated with the attendee recognition data to the mobile client device comprises:
selectively transmitting said portion of the image data associated with the attendee recognition data to the mobile client device using the recipient identifier at least partly in response both to the recipient authorization and to the first image data selection identifying the portion of the image data in response to the recipient expressing a selective authorization in the form of a user preference manifested in the mobile client device as a record relating to the recipient, wherein said first image data selection includes a subset of image data delivered onsite and after having undergone centralized image enhancement remote from the social event before the end of the social event and according to the one or more duration limitations specified by the recipient.

12. The image management method of any of the above claims, further comprising:
downloading the portion of the image data identified by the first image data selection to a viewing device remote from the social event and during the social event so that depictions of the social event are available for viewing immediately after the social event.

13. The image management method of any of the above claims, further comprising:
obtaining the identifier of the first social event, the recipient identifier associated with the first attendee, currently active attendee recognition data including the first social-event-specific appearance characteristic, and a first image of the first attendee;
obtaining the first image data selection identifying the portion of the image data from the attendee recognition data, being associated both with the first attendee in the first image and with the first social event;
transmitting a first notification concerning the image data to the mobile client device at the first social event using the recipient identifier; and
transmitting a portion of the image data associated with the attendee recognition data to the mobile client device using the recipient identifier at least partly in response both to a recipient authorization and to the first image data selection identifying the portion of the image data, wherein the first social-event-specific appearance characteristic includes a distinctive wearable material and wherein the first social-event-specific appearance characteristic is a machine-detectable event-specific attendee characteristic.

14. The image management method of any of the above claims, further comprising:
obtaining the identifier of the first social event, the recipient identifier associated with the first attendee, currently active attendee recognition data including the first social-event-specific appearance characteristic, and a first image of the first attendee;
obtaining the first image data selection identifying the portion of the image data from the attendee recognition data, being associated both with the first attendee in the first image and with the first social event;
transmitting a first notification concerning the image data to the mobile client device at the first social event using the recipient identifier; and
transmitting a portion of the image data associated with the attendee recognition data to the mobile client device using the recipient identifier at least partly in response both to a recipient authorization and to the first image data selection identifying the portion of the image data, wherein the first social-event-specific appearance characteristic includes a distinctive wearable material and wherein the first social-event-specific appearance characteristic is a machine-detectable event-specific attendee characteristic that uniquely identifies a team, party, or class of social event attendees that include the first attendee.

15. An image management system comprising:
transistor-based circuitry configured to obtain an identifier of a first social event, a recipient identifier associated with a first attendee, attendee recognition data including a first social-event-specific appearance characteristic, and a first image of the first attendee;
transistor-based circuitry configured to obtain a first image data selection from the attendee recognition data being associated both with the first attendee in the first image and with the first social event; and
transistor-based circuitry configured to transmit a first notification concerning image data to a mobile client device at the first social event using the recipient identifier; and
transistor-based circuitry configured to transmit selectively a portion of the image data associated with the attendee recognition data to the mobile client device using the recipient identifier at least partly in response both to a recipient authorization and to the first image data selection identifying the portion of the image data.
